(19) United States
(12) Patent Application Publication
(10) Pub. No.: US 2010/0089161 A1
(43) Pub. Date: Apr. 15, 2010

(54) Vibration Based Damage Detection System

(75) Inventor: Farid Taheri, Halifax (CA)

Correspondence Address: Jonathan P. O''Brien, Ph.D.;Honigman Miller Schwartz and Cohn, 350 East Michigan Avenue, Suite 300, KALAMAZOO, MI, 49007, US

(73) Assignee: Dalhousie University, Halifax, NS (CA)

(21) Appl. No.: 12/527,045

(22) PCT Filed: Feb. 15, 2008
(86) PCT No.: PCT/CA08/00302

§ 371 Date: Oct. 16, 2009

Related U.S. Application Data
(60) Provisional application No. 60/901,386, filed on Feb. 15, 2007.
(60) Provisional application No. 60/932,506, filed on May 31, 2007.

(51) Int. Cl. G01M 7/02

(52) U.S. Cl. 73/588

(57) ABSTRACT

The present invention provides methods of assessing damage on a joint that includes energizing the joint, detecting the vibration of the joint using one or more signal generating sensors, processing the signal(s), and applying a damage index to the processed signal(s), wherein the damage index incorporates a processed control signal generated by a sensor(s) at or near the joint when the joint was healthy, i.e., in a substantially undamaged state. Another aspect of the present invention provides a pipeline that includes at least two pipe segments, at least one joint connecting the two pipe segments, and at least one signal generating sensor affixed to the pipeline that is capable of detecting vibration at or near the joint, at least one signal processor that is capable of EMD processing the signal, and an output device (e.g., computer monitor, LED display, a light bulb, an electronic alarm, or other sound or light generating device).

### CLAIM OF PRIORITY

This application claims priority to U.S. provisional application Ser. No. 60/901,386, filed Feb. 15, 2007; and U.S. provisional application Ser. No. 60/932,506, filed May 31, 2007. The entire contents of each provisional application is hereby incorporated herein by reference in its entirety.

### FIELD OF THE INVENTION

The present invention concerns vibration-based damage detection systems that are particularly useful for assessing damage to joints of pipes or other structures.

### BACKGROUND

Vital resources such as oil, gas, water, and other fluid materials are transported through pipelines that span various terrains. Pipelines are critical transport elements, and their health and reliability through their designed service life are important issues for design and maintenance engineers. Factors such as changes in the structural support due to ground shifting, aging, corrosion, impacts from heavy construction equipment, pressure cracks, thermal expansion and contraction, and defective welds can severely impact the integrity of pipelines and dramatically effect the service life of pipeline segments. These factors can cause economical and environmental problems for industry stakeholders, including the producers, pipeline operators, regulatory agencies, the public, and others who are adversely effected by pipeline leakage. Thus, the creation of a safe and reliable method for detecting damage in pipelines is important.

Traditional methods for structural damage detection possess drawbacks such as the necessity of expensive equipment, poor sensitivity, and high labor costs, while other methods are not compatible with common structural pipeline materials such as plastic or metal. Some of these methods include visual inspection, impedance analysis, ultrasonic analysis, acoustic emission/transmission analysis, microwave analysis, magnetic flux leakage analysis, thermography, interferometry, and leaky lamb-wave analysis.

### SUMMARY OF THE INVENTION

The present invention provides methods of detecting damage and/or assessing relative damage on a structural joint that includes vibrating the structure that comprises the joint, mapping the vibrational response of the joint using one or more signal generating sensors, transmitting the vibrational response as a signal(s) to a processor, processing the signal(s), and applying the processed signal(s) to a damage index that yields the relative damage at the joint.

One aspect of the present invention provides a method of detecting damage in a structural joint comprising vibrating a structure that comprises at least one joint; detecting a vibrational response of the joint; transmitting the vibrational response to a processor as a signal; processing the response to obtain a test signal; and applying the test signal to a damage index.

In many embodiments, the application of the test signal to the damage index further comprises obtaining a calibration signal, wherein the calibration signal is the processed response of the vibrated joint when it is healthy; and the calibration signal is processed according to the processing of the test signal.

In other embodiments, the application of the test single to the damage indext further comprising calculating an integral of the test signal, calculating an integral of the calibration signal, calculating the difference between the integrals of the test signal and the calibration signal, and dividing the difference by the calibration signal.

In several embodiments, signal processing comprises one or more of the following actions: storage and reconstruction (e.g., phase shifting, amplification, or the like), separation of information from noise (e.g., filtering), compression (e.g., digitizing), and/or feature extraction. In other embodiments, the signal is processed using FFT, WT, or HHT.

In several embodiments, the structure is vibrated using a vibrating hammer, a tuning fork, closing a valve that controls the flow of fluid through the pipe, a piezoelectric actuator, or an electromagnetic actuator.

In several embodiments, the vibrational response of the joint is detected with a piezoelectric sensor, an accelerometer, a dynamic displacement tranducer, or a strain gauge.

In several embodiments, the signal is transmitted to the processor as electromagnetic waves or an electronic signal.

Several joints that are damage assessable using the present invention include, without limitation, joints formed by adhesively mating a male portion of a first structure with a female portion of a second structure, joints formed by mating a first flange on a terminus of a first structure with a second flange on a terminus of a second structure, or the like. Other exemplary joints are formed from the jointing of at least 2 members independently selected from: I-beams, joists, cables, wires, stanchions, trusses, pipes, or the like. In one example, the joint is formed by a joining of two pipe members. Some exemplary pipe joints include mating a first flange with a second flange. Such mating can be accomplished by bonding the first flange to the second flange with an adhesive, fastening the first flange to the second flange with at least one bolt, or other suitable methods. In other examples, the joint comprises a gasket.

Another aspect of the present invention provides a pipeline that comprises at least two pipes that are mated to form a joint, a vibrator, at least one signal generating sensor that is capable of detecting the vibrational response of the joint and transmitting it as a signal, at least one signal processor that can process the vibrational response signal and apply the processed signal to a damage index, and an output device.

The elements exemplary pipelines of this invention can function or embody any of the common elements described in the methods above. Furthermore, this novel damage detection method is useful for detecting damage in pipelines that are in use, e.g., channeling fluids from one location to another, and does not require that the flow of fluid through the pipeline be substantially affected, e.g., stopped, in order to conduct the damage assessment measurements.

### BRIEF DESCRIPTION OF THE FIGURES

FIG. 1 is a side-view illustration of three test samples that were subjected to exemplary methods of the present invention;

FIG. 2 is a graphical representation of the relative damage for test specimen 2, having ¼ debond, and test specimen 3, having ½ debond; and

FIG. 3 is a graphical representation of the relative damage for test specimen 2 as determined using signals generated from sensor 1 and sensor 2.

### DETAILED DESCRIPTION

### I. Definitions

As used herein, “detecting” means identifying the presence of a characteristic or event. For example, “detecting structural damage” or “detecting damage” means identifying the presence of damage (e.g., cracks, disbond on a joint, weak sections of pipe wall, lose fasteners (e.g., bolts, screws, or the like) on mechanically fastened joints, corrosion, or the like). In another example, “detecting a vibrational response” means identifying the presence of a vibrational response and converting the vibrational response to a signal that can be transmitted, stored, processed, or otherwise manipulated.

As used herein, “relative damage” or “damage index” refers to the following mathematical expression:

$$D I = \vert \frac{{I}_{healthy} - {I}_{test}}{{I}_{test}} \vert \times 100 \qquad ( 1 )$$

where DI is the measure of relative damage at a joint when a test measurement is taken, I_{healthy} is the value of the integral of the processed response signal of a vibrated healthy joint, and Iₜₑₛₜ is the value of the integral of the processed response signal of the vibrated joint at the time of the damage detection and/or assessment. Several methods of signal processing can be used to process the vibrational response of a joint and applied to the expression in equation (1) to determine the relative damage or damage index of the joint.

As used herein, “signal” refers to any time-varying quantity. Signals are often scalar-valued functions of time (waveforms), but may be vector valued and may be functions of any other relevant independent variable. For example, a signal produced from a sensor could be an electrical quantity or effect, such as current, voltage, or electromagnetic waves, that can be varied in such a way as to convey information.

As used herein, “processing”, “signal processing” and other verb tenses of “process” refer to the analysis, interpretation, and manipulation of one or more signals. Processing of signals, such as electrical signals, e.g., voltage, current, or electromagnetic waves, includes storage and reconstruction (e.g., phase shifting, amplification, or the like), separation of information from noise (e.g., filtering), compression (e.g., digitizing), and/or feature extraction. Some signal processing methods include Fourier Transformation processing (FT), Fast Fourier Transformation processing (FFT), Wavelet Transformation processing (WT), or Hilbert-Huang Transformation processing (HHT), without limitation.

As used herein, “noise” or “signal noise” refers to data without meaning; that is, data that is not being used to transmit a signal, but is simply produced as an unwanted by-product of other activities.

As used herein, a “processor” refers to an electronic device designed to accept data, perform prescribed mathematical and logical operations, and display the results of these operations. Examples of processors include digital and/or analogue computers, Central Processing Units (CPUs), microprocessors, and the like.

As used herein, “vibrating”, “vibrate”, “vibrated” or “vibrational” each refers to mechanical oscillations about an equilibrium point. The oscillations may be periodic such as the motion of a pendulum or random such as the movement of a tire on a gravel road. For example, vibrating a structure or a pipe is to affect the structure or pipe such that at least a portion of the structure or pipe undergoes mechanical oscillations about an equilibrium point.

As used herein, “pipe” refers to a hollow tube used for the conveyance of a fluid such as water, natural gas, propane, steam, petroleum, or the like. The cross section of a pipe can have any shape such as circular, eliptical, or rectangular.

As used herein, “joint” refers to the place at which two things, or separate parts of one thing, are joined or united, either rigidly or in such a way as to permit motion. For example, two pipes may be united at a joint, wherein a male terminus of one pipe is mated to a female terminus of a second pipe, or a male terminus of a pipe is mated with a female terminus located at a terminus opposite the male terminus in the same pipe. Furthermore, two I-beams, two cables, or two pipes may be united to form a joint using any means of anchorage such as flanges or the like.

As used herein, “dynamic response” or “vibrational response” refers to the mechanical oscillations experienced at the joint of a structure, e.g., a pipe joint, or other structural joint, when the structure is vibrated.

As used herein, “healthy” refers to a state of a structure wherein the structure is substantially free of damage. For example, a healthy pipe is a pipe that can convey a fluid throughout the pipe's length without leaking. A healthy pipe joint is a pipe joint that is substantially free of damage, wherein the term “joint” is defined above. A healthy pipe joint does not leak the fluid that it conveys. A healthy pipe joint can undergo excitation forces (e.g., vibrations or explosions in a closed field without significant loss of structural integrity, i.e., the joint does not leak and/or the joint can undergo future excitation forces. Furthermore, healthy pipes are substantially free of corrosion (e.g., a reduction of less than about 15% of the joint wall thickness, a reduction of less than about 10% of the joint wall thickness, a reduction of less than about 5% of the joint wall thickness, a reduction of less than about 1% of the joint wall thickness, or reduction of less than about 0.5% of the joint wall thickness), and fluid leaks (e.g., less than about 0.5% of the fluid flow leaks, less than about 0.1% of the fluid flow leaks, or less than about 0.05% of the fluid flow leaks).

As used herein, an “output device” is a device that creates an effect that is detectable using one of the human senses, i.e., sight, sound, smell, touch, or taste. For example, an output device could include a siren that produces an audio alarm, a computer monitor or television screen that produces images and/or displays information, or an output device can be a lightbulb or LED that emits a wavelength of electromagnetic radiation in the visible light spectrum when activated.

As used herein, “under tension” or “under some tension” refers to otherwise flexible structures or relatively inflexible structures such as cables, bars (e.g., rebar or the like), ropes, wires, or the like that are placed under at least some tension such that the structure is capable of being vibrated.

As used herein, “pipeline” refers to a structure that comprises more than 1 pipe, wherein each of the pipes is mated to at least one other pipe to form one or more joints.

As used herein, “operational pipeline” or “operating pipeline” is one that is channeling fluid from one location to another at the time of damage assessment.

As used herein, the terms “first” and “second” are used to describe separate elements and do not necessarily describe the order of the elements in either space or time. For example, a second vibrational response can precede a first vibrational response in time and/or space.

II. Methods and Structures

The present invention provides methods of detecting damage on any structure that can be vibrated using the dynamic response to detect damage and/or determine the relative damage at a joint on the structure. The present methods are also useful in detecting damage and/or determining the relative damage on a structural joint such as a pipe joint.

For example, one method of detecting damage in a structural joint comprises vibrating a structure comprising at least one joint, e.g., a pipeline, detecting a vibrational response of the joint, transmitting the vibrational response to a processor as a signal, processing the signal, and applying the processed signal to a damage index to yield the relative damage of the joint.

The damage index is expressed as

$$D I = \vert \frac{{I}_{healthy} - {I}_{test}}{{I}_{test}} \vert \times 100 \qquad ( 1 )$$

where DI is the measure of relative damage at the joint when a test measurement is taken, I_{healthy} is the value of the integral of the processed response signal of the vibrated healthy joint, and Iₜₑₛₜ is the value of the integral of the processed response signal of the vibrated joint at the time of the damage detection and/or relative damage determination. It is noted that at least some damage is present in the structural joint (e.g., pipeline joint) if DI is a nonzero number.

The signals that are applied to the damage index recited in equation (1), i.e., the vibrational response of the healthy joint and the vibrational response of the test joint, can be processed using any suitable signal processing technique as long as both vibrational responses are processed using the same technique(s). For instance, the response signal of the healthy joint undergoes FT, FFT, WT, or HHT processing, the response signal of the test joint undergoes FT, FFT, WT, or HHT processing, and the I_{healthy} and Iₜₑₛₜ for each of the signals is input into the damage index to determine damage in the joint.

In several embodiments, signal processing includes one or more of the following: shifting the phase of a signal, digitizing a signal, amplifying a signal, filtering a signal, or the like.

It is also noted that a response signal can be transformed into different domains (e.g., voltage in a time domain, acceleration in a time domain, or strain in a time domain) to better interpret the physical characteristics inherent with the original signal, depending on the processing technique applied to the vibrational response signal.

In one example, a structure comprising a joint is vibrated, a piezoelectric sensor detects the vibrational response and generates, or outputs, a vibrational response signal (voltage in the time domain) at the joint, which is transmitted to a processor. The response signal is processed using FFT. Under FFT, the integral for the joint response is expressed as

$$D {I}_{X} = \vert \frac{{I}_{X}^{healthy} - {I}_{X}^{test}}{{I}_{X}^{healthy}} \vert \times 100 \qquad ( 4 )$$

wherein I_{X} is the value of the integral of the absolute value of the FFT processed vibrational response signal, X(ω). The I_{X} value above includes the FFT-processed response signal when the tested structure is healthy or the response signal when damage to the structure is assessed. The calculation of discrete approximation of FFT can be represented by:

$${I}_{x} = {\int }_{- ∞}^{+ ∞} \vert X ( ω ) \vert d ω \qquad ( 2 )$$

where x(t) is a periodic function containing the output of the damage detection sensor(s), e.g., the piezoelectric sensor(s), with a period of T, and N is the total number of samples. Thus,

$$Δ t = \frac{T}{N} ,$$

and X(ω) is the frequency response of x(t).

The damage index for the FFT-processed signal is expressed as:

$$X ( ω ) = {\sum }_{r = 0}^{N - 1} x ( r Δ t ) {e}^{- i ω r Δ t} Δ t \qquad ( 3 )$$

where DIₓ is the measure of relative damage at the joint when a test measurement is taken, I^{healthy}_{X} is the value of the integral of the FFT-processed response signal of the vibrated healthy joint, I^{healthy}_{X} is the value of the integral of the FFT-processed response signal of the joint at the time of the damage detection and/or assessment. Structural damage is present in the joint if DI_{X} is a nonzero number.

In another example, the response signal is processed using a Wavelet method of signal processing, and the expression of equation (2) becomes:

$${I}_{x} = {I}_{{f}_{l}^{k , n}} = {\int }_{- ∞}^{+ ∞} {d}_{l}^{i , n} {( t )}^{2} d t \qquad ( 2 a )$$

wherein the wavelet packet component energy U_{f}_{ₗ}_{k,n} is the energy stored in the component signal dₗ^{i,n}(t). The recomposing {dₗ^{j,n}} is calculated according to expression (2b):

$${d}_{l}^{j , n} = {\sum }_{k} [ {h}_{l - 2 k} {d}_{k}^{j + 1 , 2 n - 1} + {g}_{l - 2 k} {d}_{k}^{j + 1 , 2 n} ] \qquad ( 2 b )$$

wherein h(k) and g(k) are discrete filters as described in Wickerhauser, M. V., (1994). Adapted Wavelet Analysis from Theory to Software, A K Peters, Ltd., Wellesley, Mass., hereby incorporated by reference. The damage index is assessed according to equation (4).

In another example that employs an Emperical Mode Decomposition method of signal processing, the expression of (2) becomes:

$$E = {\int }_{0}^{{t}_{0}} {( IMF )}^{2} d t \qquad ( 2 c )$$

wherein IMF is the first intrinsic mode function of the signal.

In another example, the vibrational response signal of the joint is generated by a piezoelectric sensor, transmitted to a processor, and processed using HHT as described in Huang, N. E, Shen, Z., Long, S. R., Wu, M. C., Shih H. H., Zheng Q., Yen N-C, Tung C. C., and Liu H. H. “The empirical mode decomposition and Hilbert spectrum for nonlinear and non-stationary time series analysis”. Proceedings of the Royal Society of London-Series A, 1998, 454: 903-995], which is hereby incorporated in its entirety by reference.

The damage index for an HHT-processed signal is:

$$D {I}_{mn} = \vert \frac{{E}_{mn}^{healthy} - {E}_{mn}^{test}}{{E}_{mn}^{healthy}} \vert \times 100 \qquad ( 5 )$$

wherein DIₘₙ is the measure of relative damage at the joint when a test measurement is taken, Eₘₙ^{healthy} is the value of the energy of the HHT-processed response signal of the healthy joint as expressed in equation (5) above, Eₘₙ^{test} is the value of the energy of the HHT-processed response signal of the joint at the time of the damage detection and/or assessment. Furthermore, in equation (4), m is the sensor number and the degree of freedom of the structure, n is the mode shape number. Damage is present in the structural joint when DIₘₙ is a nonzero number.

Damage indices can be similarly developed for signals processed using WT.

The damage indices of the present invention, such as those described in equations (1), (4), and (5), each have a term that represents the value of the integral of the processed response signal of a healthy joint. In the damage index, this term represents a control value that is used to measure the amount of relative damage in a structural joint at the time when the damage detection and/or relative damage is measured.

The damage indices are useful for detecting structural damage in a joint as well as the measuring the relative amount of damage. For instance, if the relative damage determination yields a nonzero number, then some damage is present in the joint.

As will be appreciated by one skilled in the art, the term “calibration signal” means the processed signal of the vibrational response of a healthy joint. “Test signal” means the processed signal of the vibrational response of a joint that is assessed for damage.

It is also appreciated that the vibrational response of the healthy joint can be measured when the joint is first assembled or at any other time that the joint is thought to be healthy. For example, the vibrational response of a healthy joint can be measured daily, weekly, monthly, annually, or continuously, so long as the joint remains healthy.

In one aspect, the present invention provides a method of detecting damage and/or determining the relative damage in a joint of a structure. In one example, the method of detecting damage and/or determining the amount of relative damage in a joint of a structure comprises vibrating a structure (e.g., a pipeline) having at least one joint, detecting or mapping a vibrational response from the vibrated joint, transmitting the vibrational response to a processor as a signal, processing the signal to obtain a test signal, and applying the test signal to a damage index.

In several embodiments, the application of the test signal to the damage index further comprises obtaining a calibration signal, wherein the calibration signal is the processed response of the vibrated joint when it is healthy; and the calibration signal is processed according to the processing of the test signal, or vice versa. Thus, the calibration signal is processed exactly as the test signal is processed.

In other embodiments, the application of the test signal to the damage index further comprises obtaining a calibration signal, wherein the calibration signal is measured when the structure is subject to approximately the same conditions as the structure experiences when the test signal is measured. For instance, in one example, the structure is a pipeline, and both the calibration signal and the test signal are measured when the pipeline is operating, or both the calibration signal and the test signal are measured when the pipeline is not operating, e.g., not transporting a fluid.

In other embodiments, the application of the test signal to a damage index further comprises calculating an integral of the test signal, i.e., the area or approximate area under the trace of the test signal, calculating an integral of the calibration signal, i.e., the area or approximate area under the trace of the calibration signal, calculating the difference between the integrals of the test signal and the calibration signal, and dividing the difference by the calibration signal.

In another embodiment, the present invention provides a method of detecting damage and/or determining the amount of relative damage in a joint that mates more than one pipe (e.g., 2 or more pipes, 3 or more pipes, or 4 or more pipes). In one example, the method comprises vibrating a pipeline, detecting or mapping a vibrational response from the vibrated joint, transmitting the vibrational response to a processor as a signal, processing the signal, and applying the processed signal to a damage index, which yields the amount of relative structural damage in the joint. A sensor that detects or maps the vibrational response from a vibrated joint can be situated anywhere such that the vibrational response of the exited joint is detected or mapped (e.g., the sensor is placed on the joint).

The methods of the present invention are useful for detecting damage and/or determining the amount of relative damage in joints on structures. Suitable structures include beams (e.g., I-beams or the like), pipes, cables or wires that can be vibrated (e.g., the cable or wire is under at least some tension), or the like. These structures can comprise members that are joined using any suitable coupling method. Such coupling methods include, without limitation, adhesively bonding structural members, mechanically joining the members (e.g., with bolts, nails, screws, rivets, collars, friction, combinations thereof, or other fasteners), welding the members together, screwing a male member into a female member, combinations thereof, or the like.

In the present methods, the vibrational response of a vibrated joint is detected and/or mapped using any suitable sensor(s), the response is transmitted as a signal, processed using any suitable signal processing methods, and applied to a damage index to yield the relative damage to the structural joint. Sensors useful in detecting and/or mapping the vibrational response of a joint and transmitting the response as a signal include, without limitation, piezoelectric sensors, accelerometers, dynamic displacement tranducers, strain gauges, or the like. Structures can be vibrated using any suitable method. For example, a pipeline can be vibrated by suddenly closing or opening a valve upstream or downstream from the joint while a fluid is flowing through the pipeline. In other examples, the structure or pipeline is vibrated by striking it with a hammer, contacting it with a piezoelectric actuator, contacting it with a tuning fork, contacting it with an electromagnetic actuator, exposing the joint to electromagnetic radiation, or the like.

One embodiment provides a method of detecting damage and/or determining the amount of relative damage to a pipeline joint comprising vibrating the pipeline (e.g., using a piezoelectric actuator, or by suddenly closing or suddenly opening a value upstream or downstream of the joint that halts or permits the flow of fluid therethrough), detecting the vibrational response of the joint using a piezoelectric sensor, transmitting the response as a signal to a processor, processing the signal using any suitable signal processing method (e.g., HHT, FT, FFT, WT, or the like), and applying the processed signal to a damage index to yield the relative damage to the structural joint.

One embodiment of the present invention provides methods of detecting damage and/or determining the amount of relative damage in an operating pipeline. Like several embodiments described above, this method includes vibrating the pipeline that comprises at least one joint; detecting a first vibrational response of the joint; transmitting the first vibrational response to a processor as a first signal; processing the first signal to obtain a test signal; and applying the test signal to a damage index. Several examples further include obtaining a calibration signal, wherein the calibration signal is processed according to the processing of the test signal; calculating an integral of the test signal; calculating an integral of the calibration signal; calculating the difference between the integrals of the test signal and the calibration signal; and dividing the difference by the calibration signal.

It is noted that the operating pipeline can be actively transferring fluid at any rate (volume per unit time) that does not exceed its intended transfer capabilities, e.g., the fluid rate does not cause immediate structural failure in the pipeline. Furthermore, examples of this embodiment can employ any of the signal processing techniques above as long as both vibrational responses are processed using the same technique(s). For instance, the response signal of the healthy joint undergoes FT, FFT, WT, or HHT processing, the response signal of the test joint undergoes FT, FFT, WT, or HHT processing, and the I_{healthy} and Iₜₑₛₜ for each of the signals is input into the damage index to determine damage in the joint. For instance, signal processing includes one or more of the following: shifting the phase of a signal, digitizing a signal, amplifying a signal, filtering a signal, or the like.

Other examples of this embodiment employ one or more sensors to detect vibrational response such as piezoelectric sensors, accelerometers, dynamic displacement tranducers, strain gauges, or the like. The operating pipeline can be vibrated using any suitable method. For example, the pipeline can be vibrated by suddenly closing or opening a valve upstream or downstream from the joint while a fluid is flowing through the pipeline. In other examples, the structure or pipeline is vibrated by striking it with a hammer, contacting it with a piezoelectric actuator, contacting it with a tuning fork, contacting it with an electromagnetic actuator, exposing the joint to electromagnetic radiation, or the like.

Another aspect of the present invention provides methods of assessing the amount of damage to a structural joint comprising creating a calibration curve and applying an amount of relative damage corresponding to an unknown amount of actual damage to the curve to yield an actual amount of damage in the joint.

In one embodiment, the amount of damage to a joint can be approximated using the damage index of the present invention to construct a calibration curve from damage index values, DI_{damage}, for the joint, comparing a test damage index value, DIₜₑₛₜ, to the curve, and extrapolating an approximate amount of damage to the joint. DI_{damage} values are damage index values of a joint having known amounts of damage (e.g., the joint has 90% of its structural integrity or the like) and DIₜₑₛₜ is the damage index value for the joint having an unknown amount of damage. In one example, a calibration curve is created by plotting various DI_{damage} values as a function of damage present in the joint wherein each DI_{damage} value has a corresponding known amount of damage. A curve is fitted to the DI_{damage} data points, DIₜₑₛₜ is plotted on this curve, and the relative damage to the joint is extrapolated from its corresponding independent variable on the calibration curve.

In many examples, a calibration curve is created by plotting at least 1 sample data point, i.e., at least DI_{failure}, through the origin, wherein DI_{failure} is the value of the damage index when the joint has a known amount of damage and that amount of damage approximates the amount of damage sufficient to cause structural failure in the joint. In other examples, the calibration curve includes more than 2 data points, (e.g., at least 3 sample data points, at least 4 sample data points, at least 5 sample data points, or at least 6 sample data points) wherein each data point represents a DI_{damage} value for a known amount of actual damage to a sample joint. The amount of actual damage that corresponds to an amount of relative damage can be determined by applying the amount of relative damage to the equation of the fitted line and solving for the amount of actual damage as a function of relative damage.

For example, a calibration curve can be created using three sample pipelines, wherein each of the pipelines comprises pipes having the same inner and outer diameters, length, and number of joints. In one sample pipeline, the pipeline joint is comprises an adhesive bond that circumnavigates 50% of the circumference of the joint. In a second sample, the adhesive bond circumnavigates 75% of the circumference of the joint. In a third sample, the adhesive bond circumnavigates 100% of the circumference of the joint. The relative damage for each of these samples is determined and plotted against their corresponding amounts of actual damage, i.e., no actual damage, 25% actual damage, and 50% actual damage, wherein the actual damage is represented by the percentage of the circumference of the joint that is unbonded. A line is then fitted to the three data points. To quantitatively determine the amount of unknown actual damage that corresponds to an amount of relative damage, apply the amount of relative damage to the equation of the fitted line to yield an amount of actual damage to the joint.

It is noted that lines can be fitted to data points to create a calibration curve using any suitable method. For example, linear regression, non-linear regression, or other curve fitting methods may be used to create a calibration curve corresponding to sample data points.

Another aspect of the present invention provides a pipeline comprising at least 2 pipes that are mated to form a joint, a vibrator, at least one sensor that can detect the vibrational response of a joint and transmit the response as a signal to a processor, a processor that can process the vibrational response signal and apply the processed signal to a damage index, and an output device.

### III. EXAMPLES

### Example 1

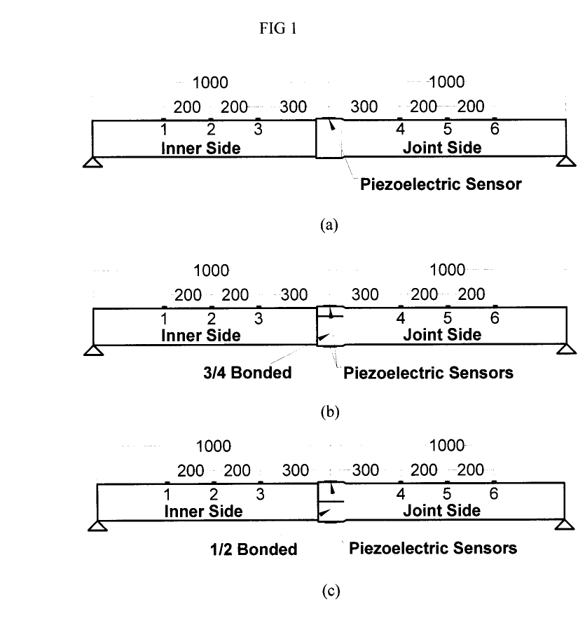

Referring FIG. 1, three different test specimens were used to demonstrate the present damage detection method. Three PVC pipe joints were prepared using IPEX 6 inch diameter PVC sewer pipes, with the dimensions shown in FIG. 1. The procedure used to prepare each of the bonded joints was as follows:

The pipe sections were cut to the appropriate length using a band saw;

The surfaces of the bonding regions were cleaned with isopropyl alcohol;

IPEX XIRTEC 7 primer was applied to the bonding regions;

IPEX XIRTEC 11 PVC cement was applied to the bonding regions;

The two sections of pipe were inserted into one another; and

The PVC cement was cured for a few minutes.

For the first test specimen, the joint is fully bonded around its entire circumference. For the second test specimen, the joint is bonded around approximately ¾ of the joint's circumference. In the third test specimen, the joint is bonded around approximately ½ of its circumference. See Table 1 below:

TABLE 1
Joint adhesive bond for each test specimen

| Test Specimen | Damage Present |
|---|---|
| 1 | No Damage |
| | (Fully Bonded) |
| 2 | ¾ |
| | Circumference |
| | bond |
| 3 | ½ Circumference |
| | bond |

The piezoelectric patches used in this example were QP15N PZT QuickPack strain sensors available from Mide Technology Corporation (Medford, Mass.). These patches were bonded to the surface of the pipe at the joint region, using the West System's two-part epoxy. Once the patches were positioned, the epoxy resin was allowed to set for approximately 12 hours under a vacuum at 20 in Hg. On the test specimens containing unbonded regions, i.e., Test Specimens 2 and 3, piezoelectric sensors were positioned at the center of the unbonded region of the joint and at a position 180° around the circumference of the joint from that sensor. For the fully bonded pipe, there was only one sensor bonded at the center of the joint. Refer to FIG. 1 for illustrations of the exemplary test subjects.

Referring to FIG. 1, the specimens were set up with metallic supported flanges. The supports of the pipes were set up using 6 inch cast iron flanges that were fastened to a steel platform. In order to fit the pipe section to the supports, larger IPEX 6 inch PVC Blue Brute water pipes were milled to fit tightly over the termini of the pipes. Once the Blue Brute piping sections were fitted to the ends of the pipes, they were clamped into the flanges, as shown in Table 1.

TABLE 2
Impulse hammer impact locations

| Impact Location | | Distance |
|---|---|---|
| Number (TEST | | From |
| NO.) | Impacted Side | Joint Center |
| 1 | Bottom Side | 300 mm |
| 2 | Bottom Side | 500 mm |
| 3 | Bottom Side | 700 mm |
| 4 | Top Side | 300 mm |
| 5 | Top Side | 500 mm |
| 6 | Top Side | 700 mm |

In Table 2, the impact location numbers correspond with the locations identified in the illustrations in FIG. 1.

The dynamic response of the each of the examples was monitored at the joint location. The responses of the piezoelectric sensors were continuously monitored using a computer having a multipurpose PCI DT3010 data acquisition card manufactured by Data Translation (MA, USA), and using a differential channel configuration. The data acquisition programs used to monitor the piezoelectric responses was developed in VEE Pro, which is a visual programming software. 40,000 data points were monitored for each test at a rate of 10 kHz. The computer was also equipped with a power conditioner, which removed noise from the system. Every test was conducted by starting the data acquisition systems, then impacting the desired location with the impulse hammer. Three tests were performed for each experimental set-up.

The loading of the specimens was applied with a PCB Piezotronics 086B01 impulse hammer. The impulse hammer response was monitored continuously using a DT-24EZ data acquisition card, also manufactured by Data Translation (MA, USA), with a single ended channel configuration. The data acquisition programs used to monitor the impulse hammer response were developed in LabVIEW, with the use of the DT-LV Link. The signal of the impact hammer was monitored at the rate of 20,000 data points at 10 Hz. The response of the impulse hammer (in mV), was amplified with the use of a PCB Piezotronics Inc. series 790 power amplifier. The power amplifier also eliminated most of the noise from the impulse hammer response signal.

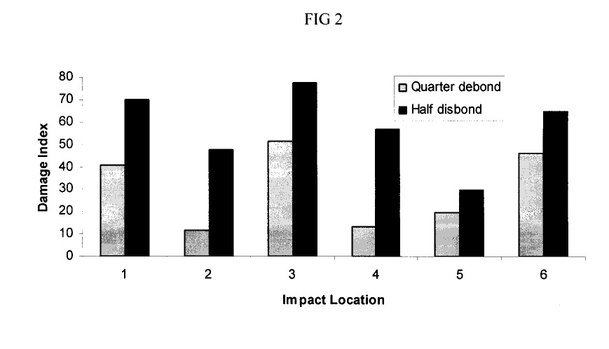

The damage indices are shown in FIG. 2 for the two sensors placed at the joint of test specimen 2 and 3 for tests 1-6, respectively.

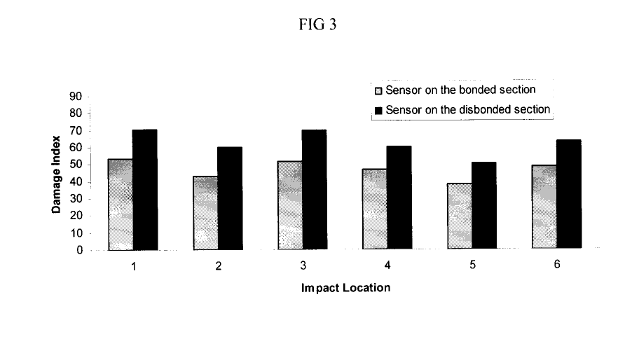

FIG. 3 graphically illustrates the amount of relative damage for test specimen 2 as determined using signals generated from sensor 1 and sensor 2.

### OTHER EMBODIMENTS

All publications and patents referred to in this disclosure are incorporated herein by reference to the same extent as if each individual publication or patent application were specifically and individually indicated to be incorporated by reference. Should the meaning of the terms in any of the patents or publications incorporated by reference conflict with the meaning of the terms used in this disclosure, the meaning of the terms in this disclosure are intended to be controlling. Furthermore, the foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

1. A method of detecting damage in a structural joint comprising:
Vibrating a structure that comprises at least one joint;
Detecting a first vibrational response of the joint;
Transmitting the first vibrational response to a processor as a first signal;
Processing the first signal to obtain a test signal; and
Applying the test signal to a damage index.

2. The method of claim 1, wherein processing the signal comprises storage and reconstruction of the signal.

3. The method of claim 1, wherein processing the signal comprises filtering the signal.

4. The method of claim 1, wherein processing the signal comprises compressing the signal.

5. The method of claim 1, wherein processing the signal comprises signal feature extraction.

6. The method of claim 1, wherein processing the signal comprises shifting the phase of the signal.

7. The method of claim 1, wherein processing the signal comprises amplifying the signal.

8. The method of claim 1, wherein processing the signal comprises digitizing the signal.

9. The method of claim 1, wherein processing the signal comprises filtering the signal.

10. The method of claim 1, wherein applying the test signal to a damage index further comprises obtaining a calibration signal, wherein the calibration signal is the processed response of the vibrated joint when it is healthy; and the calibration signal is processed according to the processing of the test signal.

11. The method of claim 10, further comprising calculating an integral of the test signal, calculating an integral of the calibration signal, calculating the difference between the integrals of the test signal and the calibration signal, and dividing the difference by the calibration signal.

12. The method of claim 1, wherein the structure is vibrated using a vibrating hammer, a tuning fork, a piezoelectric actuator, or an electromagnetic actuator.

13. The method of claim 1, wherein the structure is vibrated using a vibrating hammer or a tuning fork.

14. The method of claim 1, wherein the structure is a pipe and the pipe is vibrated using a vibrating hammer, a tuning fork, a piezoelectric actuator, closing a valve that controls the flow of fluid through the pipe, or an electromagnetic actuator.

15. The method of claim 1, wherein the first vibrational response and/or the vibrational response of the healthy joint is detected with a piezoelectric sensor, an accelerometer, a dynamic displacement tranducer, or a strain gauge.

16. The method of claim 1, wherein the first vibrational response and/or the vibrational response of the healthy joint is detected with a piezoelectric sensor.

17. The method of claim 1, wherein the signal is transmitted to the processor as electromagnetic waves or an electronic signal.

18. The method of claim 1, wherein the test signal is processed using FFT, or HHT.

19. The method of claim 1, wherein the structure comprises a first pipe that is joined to a second pipe to form a joint.

20. The method of claim 1, wherein the joint further comprises a gasket.

21. A pipeline comprising:
At least 2 pipes that are mated to form a joint;
A structural vibrator;
At least one sensor that can detect the vibrational response of a joint and transmit the response as a signal to a processor;
A processor that can process the vibrational response signal and apply the processed signal to a damage index; and
An output device.

22. The pipeline of claim 21, wherein at least one of the pipes comprises a plastic, a metal, a concrete, or any combination thereof.

23. The pipeline of claim 21, wherein at least one of the pipe segments comprises a plastic selected from a thermoplastic and/or a thermoset.

24. The pipeline of claim 21, wherein at least one of the pipe segments comprises a metal selected from aluminum, steel, cast iron, copper, or any combination thereof.

25. The pipeline of claim 21, wherein the structural vibrator comprises a hammer, a piezoelectric actuator, a tuning fork, or a valve.

26. The pipeline of claim 25, wherein the structural vibrator comprises a piezoelectric actuator.

27. The pipeline of claim 21, wherein the sensor comprises a piezoelectric sensor, an accelerometer, a dynamic displacement transducer, or a strain gauge.

28. The pipeline of claim 27, wherein the sensor comprises a piezoelectric sensor.

29. The pipeline of claim 21, wherein the processor comprises a computer.

30. The pipeline of claim 21, wherein the output device is a LED, a LCD display, a computer monitor, an audio alarm, or any combination thereof.

31. A method of detecting damage in a structural joint of an operating pipeline comprising:
Vibrating the pipeline that comprises at least one joint;
Detecting a first vibrational response of the joint;
Transmitting the first vibrational response to a processor as a first signal;
Processing the first signal to obtain a test signal;
Obtaining a calibration signal;
Applying the test signal to a damage index, wherein the calibration signal is processed according to the processing of the test signal;
Calculating an integral of the test signal;
Calculating an integral of the calibration signal;
Calculating the difference between the integrals of the test signal and the calibration signal; and dividing the difference by the calibration signal.
